(19) United States
(12) Patent Application Publication
(10) Pub. No.: US 2025/0289085 A1
(43) Pub. Date: Sep. 18, 2025

(54) ASSEMBLY SYSTEM COMPRISING A WORKSTATION ENCLOSURE AND A TRANSPORT VEHICLE, AND METHOD FOR TRANSFERRING A WORK OBJECT BETWEEN A TRANSPORT VEHICLE AND A WORKSTATION ENCLOSURE

(71) Applicant: Dürr Systems AG, Bietigheim-Bissingen (DE)

(72) Inventors: Nico STUTZNÄCKER, Sachsenheim (DE); Michael LAUER, Bietigheim-Bissingen (DE)

(21) Appl. No.: 18/860,463

(22) PCT Filed: May 4, 2023
(86) PCT No.: PCT/DE2023/100321

§ 371 Date: Oct. 25, 2024

(30) Foreign Application Priority Data
May 6, 2022 (DE) 10 2022 111 317.5

(51) Int. Cl. B23P 21/00

(52) U.S. Cl. CPC B23P 21/004; B23P 2700/50

(57) ABSTRACT

The present invention relates to an assembly system comprising a workstation enclosure (100) in which assembly and/or machining activities can take place on a work object (127), and a transport vehicle (107) on which the work object (127) can be releasably mounted. In order to offer an even more flexible assembly strategy, the invention is characterized in that the workstation enclosure (100) is provided with an entrance (112) and an exit (113), a guide path (114) being provided between the entrance (112) and the exit (113), along which guide path the transport vehicle (107) can be guided from the entrance (112) to the exit (113). The invention also relates to a method for transferring a work object (127) between a transport vehicle (107) and a workstation enclosure (100).

### RELATED APPLICATION

This application is a national phase of international application No. PCT/DE2023/100321 filed on May 4, 2023, and claims the benefit of German application No. 10 2022 111 317.5 filed on May 6, 2022, which are incorporated herein by reference in their entirety and for all purposes.

### FIELD OF DISCLOSURE

Examples disclosed herein relate to an assembly system comprising a workstation enclosure and a transport vehicle. In the prior art, production systems are known, for example from automobile production, in which one work step after the other is carried out in a line form.

### BACKGROUND

However, to increase flexibility, so-called workstation enclosures are nowadays often set up in the factory halls. These are clearly defined regions in which assembly and/or machining activities are performed on work objects, such as vehicles or vehicle bodies.

### SUMMARY

Examples disclosed herein offer an even more flexible assembly strategy.

Examples disclosed herein propose simplifying the transfer of the work objects between transport vehicles, known per se, and the workstation enclosure.

Such transport vehicles are often also known as driverless transfer vehicles. Such a transport vehicle usually has a surroundings scanner that monitors the surroundings of the transport vehicle. The movement or travel path of the transport vehicle, with the work object mounted thereon, is usually adjusted based on the information recorded by the surroundings scanner.

Examples disclosed herein are characterized in particular in that the workstation enclosure has an entrance and an exit, with a guide path being provided between the entrance and the exit, along which guide path the transport vehicle can be guided from the entrance to the exit. The work object mounted on the transport vehicle is, for example, transferred from the transport vehicle to the workstation enclosure. Corresponding assembly and/or machining activities can be carried out on the work object in the workstation enclosure. The transport vehicle preferably travels largely under the workstation enclosure and from the entrance to the exit along the guide path. After the assembly and/or machining activity in the workstation enclosure, the work object is for example transferred back to the transport vehicle and can then be driven by the transport vehicle to a further workstation enclosure or used for other purposes.

In particular, it is advantageous that the entrance and/or the exit in the workstation enclosure is wider in the cross-sectional direction compared to a transverse direction of the guide path; in particular, the entrance and/or the exit is 30% or more wider in its cross section than the guide path. Other advantageous ranges are 40% or more wider, 50% or more wider, 100% or more wider, 200% or more wider, 1000% or more wider. The aforementioned values can be not only the lower limit, but also the upper limit of the width of the entrance or exit in relation to the guide path.

A kind of entry or exit funnel can thus be provided. With the usual dimensions of such transport vehicles, this entry funnel or exit funnel can have a width of 3 m and a depth of 1 m. Other preferred widths are 4 m, 5 m, 6 m. Other preferred depths are 2 m, 3 m, 4 m, 5 m, 6 m, 7 m. The aforementioned width and depth values can also be upper and lower limits of preferred widths and depth ranges, respectively.

The entrance or exit is provided to be wider since, in the first place, this is a safety feature and prevents people (workers) in the vicinity of the transport vehicle from being forced into the exit or entrance. In addition, this size is also advantageous insofar as the transport vehicle collects the information using its surroundings scanner and moves independently It can thus make its way more easily into the workstation enclosure or out of the workstation enclosure.

According to an advantageous development of examples disclosed herein, it has for example, between the entrance and the exit, a guide path defined by mutually opposite longitudinal walls. Alternatively or in addition, route markings can also be provided which specify a route of the transport vehicle beneath the workstation enclosure. The surroundings scanner of the transport vehicle can, for example, take these route markings and/or longitudinal walls into account and align the route of the transport vehicle accordingly. A set-up of this kind predetermines the route of the transport vehicle from the entrance to the exit.

In particular, as described above, the transport vehicle can have a surroundings scanner which scans the surroundings of the transport vehicle, and the transport vehicle can adapt its route, in particular independently, both the route below the workstation enclosure and the route within the production facility, to the information obtained from the surroundings scanner. For example, the transport vehicle travels independently into the entrance and/or from one workstation enclosure to the next workstation enclosure on the basis of the information from the surroundings scanner.

On the one hand, the route of the transport vehicle under the workstation enclosure can be determined by a control loop composed of scanner information and surroundings information. Alternatively, a fixed route can also be specified by a controller, and the fixed route can be defined on the basis of the position of the transport vehicle under the workstation enclosure. Alternatively, the guide path can also come into contact with the transport vehicle, for example, and thus guide the latter by mechanical interaction.

In particular, the assembly system can have a communications interface that allows the transport vehicle to communicate with the workstation enclosure. In addition to such a communications interface, through which data can be exchanged, the entire system can be controlled via a higher-level controller that is used for the entire production facility.

According to an advantageous development of examples disclosed herein, the workstation enclosure can have a work-object lifting panel onto which the work object can be transferred from the transport vehicle. On such a work-object lifting panel, the work object can then be lifted, for example, from a lower position, which corresponds for example to a transfer position of the work object from the transport vehicle to the work-object lifting panel, into an upper position or any intermediate position. A worker (person carrying out work activities on the work object in the workstation enclosure) who is performing the corresponding assembly and/or machining steps on the work object can thus better reach the work object or also work on the work object from below.

The workstation enclosure can have a floor, in particular a substantially planar floor, in which a slot is provided between the entrance and the exit. One or more mounting means, which are provided on the transport vehicle and by means of which the work object is releasably attached to the transport vehicle, can protrude into this slot from the underside.

While the transport vehicle is passing through from the entrance to the exit under the workstation enclosure, the work object can be transferred to the work-object lifting panel. In particular, this can happen at a position while the transport vehicle is positioned under the work-object lifting panel. While the work object is then in place on the work-object lifting panel, assembly and/or machining activities can accordingly be carried out on the work object. Afterwards, for example, the work object on the work-object lifting panel is lowered again until it is in the transfer position and is transferred to the transport vehicle, for example by being fixed again to the mounting means on the transport vehicle. Thereafter, the transport vehicle can drive the work object attached to it out of the workstation enclosure again through the exit.

The slot is preferably provided with a seal, in particular a labyrinth seal, which closes the slot from above if no section of the mounting means or a section of the work object or a connecting element provided between the work object and the mounting means protrudes from below through the slot into the workstation enclosure.

On the one hand, this seal ensures that no parts fall into the path of the transport vehicle under the workstation enclosure, and, on the other hand, a worker moving about on the floor of the workstation enclosure can also be better protected from tripping hazards.

In particular, the work-object lifting panel can also have a further slot that is aligned with the slot in the floor of the workstation enclosure. When the work object is transferred from the transport vehicle to the work-object lifting panel, the mounting means essentially also protrudes through the further slot into the work-object lifting panel.

In particular, the workstation enclosure can be formed by a planar platform, which is delimited in particular by fence or wall elements. A planar platform of this kind offers a demarcation of the workstation enclosure in the work hall.

According to a further embodiment, the workstation enclosure has, at the entrance, an input conveyor track element, which is provided, for example, on an input lifting panel. By means of this input lifting panel, the input conveyor element can be moved from a lower position, which corresponds to a transfer position from the transport vehicle to the input conveyor element, to an elevated position, which corresponds to a transfer position from the input conveyor element to an assembly and/or machining conveyor belt element that is explained later.

Additionally or alternatively, an output conveyor track element and correspondingly an output lifting panel assigned to this output conveyor track element can also be provided at the exit. In a lower position, this output lifting panel can then transfer the work object back to the transport vehicle. The elevated position is, for example, a transfer position from the assembly and/or machining conveyor track element to the output conveyor track element.

Thus, an example disclosed herein according to this development is characterized in that the work object is first transferred from the transport vehicle to an input conveyor track element and is then brought to the appropriate height via the input lifting panel, so that it can be transferred to a further assembly and/or machining conveyor track element. The machining and/or assembly steps on the work object can then take place in the region of the assembly and/or machining conveyor track element, for example using robots. After assembly and/or machining, the work object can then be transferred from the assembly and/or machining conveyor track element to the output conveyor track element, then lowered again by means of the output lifting panel and then accordingly transferred to the transport vehicle and carried out of the exit by the transport vehicle.

The respective conveyor track element (input conveyor track element, output conveyor track element) can have a corresponding slot, as mentioned above for the explained floor. A corresponding mounting means or a section of the work object can extend into this slot from the underside. Such a slot can also be provided with a corresponding seal.

According to a further development of examples disclosed herein, the workstation enclosure can have, above the guide path, an assembly and/or machining conveyor track element, which is fixedly mounted at such a vertical height that the work object can be fed from the input conveyor track element to the assembly and/or machining conveyor track element only when the input lifting table panel has performed a predetermined stroke in the height direction, and/or that the work object can be fed from the assembly and/or machining conveyor track element to the output conveyor track element only when the output lifting panel has performed a predetermined stroke in the height direction.

The assembly and/or machining conveyor track element is therefore higher relative to the floor of the work hall. This can be beneficial if, for example, work has to be carried out from underneath the work object. The assembly and/or machining conveyor track element can be designed such that it does not have a slot in its longitudinal direction.

This can be the case because this assembly and/or machining conveyor track element is in fact elevated relative to the input conveyor track element or output conveyor track element, so that there is no interaction in the height direction with the transport vehicle.

One or more robots can be provided along the assembly and/or machining conveyor track element, which robots are configured accordingly to carry out corresponding assembly and machining steps on the workpiece. An example of a machining step is also a painting step or another coating step.

According to an advantageous development of examples disclosed herein, the workstation enclosure can also have a continuous conveyor track element which is fixed in height and which extends from the entrance to the exit, wherein the work object is transferred, in the entrance, from the transport vehicle to an input conveyor track section of the corresponding conveyor track element and is transferred, at the exit, to the transport vehicle from an output conveyor track section of the conveyor track element. Thus, in contrast to the elevated conveyor track element described above, the conveyor track element is a uniform conveyor track element that can project beyond a platform of the workstation enclosure in the input direction or output direction, for example in a horizontal direction.

In particular, the workstation enclosure described above can, for example, have a hanger by means of which the work object can be picked up from the conveyor track element and suspended.

The work object is therefore first transferred from the transport vehicle to the conveyor track element. It is then transferred from the conveyor track element to the hanger. After the assembly and/or machining steps, it is placed back onto the conveyor track element from the hanger and conveyed outward from there and then transferred again to the transport vehicle at the exit.

With regard to the various embodiments described above, a transfer of the work object from the transport vehicle can take place either directly at the input side and/or output side or only within the workstation enclosure, in particular centrally in the workstation enclosure or centrally with respect to the corresponding guide path.

The aforementioned conveyor track elements can be oriented such that they are pivotable in the longitudinal direction. This is sometimes necessary because these conveyor track elements can be folded over so that the route along which the transport vehicle travels, i.e. the guide path, is accessible.

According to a secondary aspect of examples disclosed herein, a method for transferring a work object between a transport vehicle and a workstation is also specified. The method has the features of claim 23.

The aforementioned aspects can all be provided for the corresponding method. A transfer of the work object between the transport vehicle and the workstation enclosure can be carried out in the various positions that have been previously described. Thus, all of the device features described above can also be specified in method form.

Although examples disclosed herein refer quite generally to a work object, a specific example here can be a vehicle body or a vehicle part to be manufactured.

Although three separate embodiments are described below, the elements of the various embodiments can also be combined with one another or interchanged with one another. The hanger can also be provided in the variant with the higher conveyor track element, and/or the worker lifting panel can be provided in the variant with one or more robots, to name just a few possible permutations or other combinations.

Further advantageous embodiments of examples disclosed herein are described below with reference to the drawings.

### BRIEF DESCRIPTION OF THE DRAWINGS

FIGS. 1 to 3 show different views of a first exemplary embodiment of examples disclosed herein, in which the workstation enclosure is designed as a manual workstation with a work-object lifting panel and a worker lifting panel, and in which the work object is transferred from the transport vehicle relatively centrally in the workstation enclosure;

FIGS. 4 to 7 show different views of a second exemplary embodiment, in which the workstation enclosure is what is called an automatic enclosure, in which a raised assembly or machining conveyor track element is provided, which is surrounded by corresponding machining robots;

FIGS. 8 to 10 show different views of a third exemplary embodiment, in which the workstation is what is called a UBS enclosure, in which a continuous conveyor track element is provided which extends over the platform of the workstation enclosure at the input side and output side.

Although specific exemplary embodiments are described with reference to the following figures, examples disclosed herein are not limited to these.

Although a hanger is provided for the third embodiment, for example, such a hanger can also be provided in conjunction with all other embodiments. Each of the corresponding elements of the embodiments can also be correspondingly combined to form new embodiments that are not shown.

### DETAILED DESCRIPTION OF THE DRAWINGS

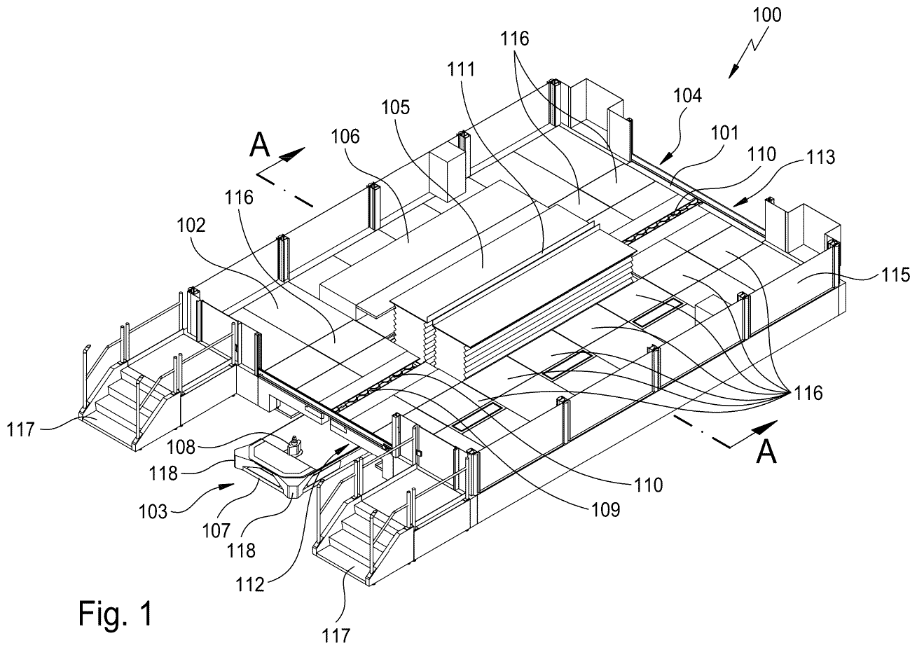

FIGS. 1 to 3 show a first embodiment, in which a workstation enclosure 100 is a manual workstation enclosure 100.

The workstation enclosure 100 has a platform 101, which contains a floor 102. In the present example, the platform 101 is limited by a fence 115. This fence 115 can also be designed as a wall.

The side of the platform 101 designated by reference sign 103 is an input side; the side of the platform 101 designated by reference sign 104 is an output side. The entrance 112 is provided at the input side 103. The exit 113 is provided at the output side 104. In the exemplary embodiment, the transport vehicle has reference sign 107. The transport vehicle is provided as a rollable planar element with a flat top surface, on which in the present case two mounting means 108 are provided, which protrude from the surface as vertical pins.

During the passage of the transport vehicle 107 from the entrance 112 to the exit 113 through the schematically indicated guide path 114 below the platform 101, the mounting means 108 are guided within a slot 109, on the side walls of which a seal 110 is provided which covers the slot 109, so that no parts can fall there into the guide path 114 and/or so that the worker (not shown) can walk on the floor 102 and carry out assembly or machining activities on the work object (not shown), which can be a vehicle or a vehicle body, for example.

A so-called work-object lifting panel 105 is provided centrally on the floor 102 of the platform 101. A worker lifting panel 106 is provided to the side of the work-object lifting panel 105. A worker can position himself on the worker lifting panel 106 and adjust a height in the height direction to the work object stored on the work-object lifting panel 105.

The slightly raised platform 101 is accessed via the corresponding stairs 117.

The floor 102 also has plate elements, in the present case provided as grid elements, which are described below as access elements 116. These are removable or can be folded aside. In this way, access to the underlying guide path 114 or to the entrance 112 and the exit 113 can be ensured.

A work object (not shown) is attached to the mounting means 108 on the transport vehicle 107 and is thus moved into the entrance 112 of the workstation enclosure 100 and then continues along the guide path 114.

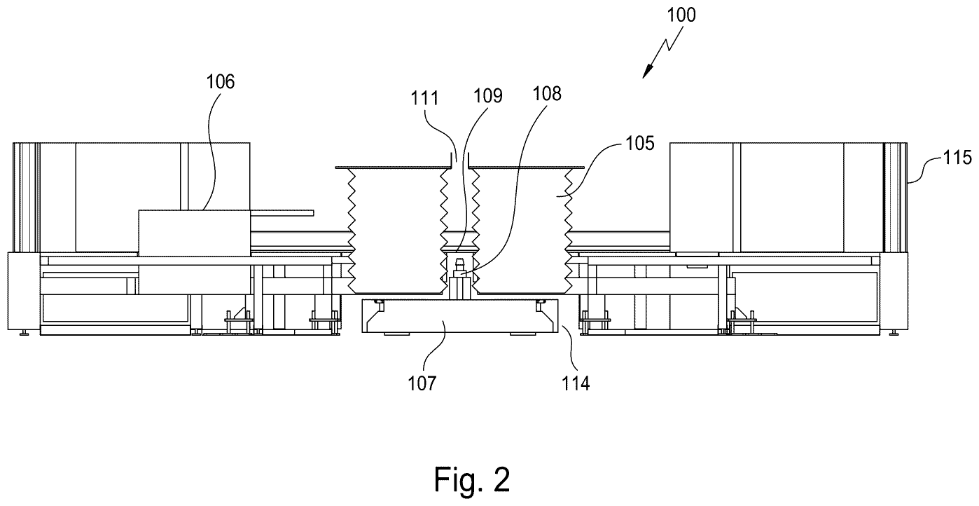

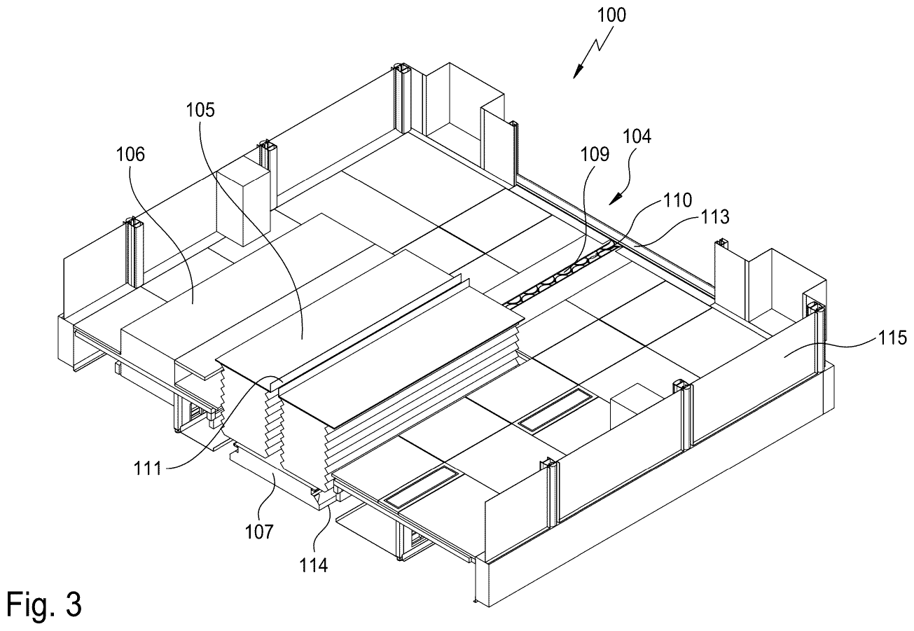

In the present exemplary embodiment, the work object is transferred from the transport vehicle 107 to the work-object lifting panel 105 at the middle of the platform 101 in the region of the work-object lifting panel 105, when the transport vehicle 107 is provided essentially under the work-object lifting panel 105. This position can be seen in FIGS. 2 and 3. In contrast to FIG. 1, the transport vehicle in FIGS. 2 and 3 is positioned below the work-object lifting panel 105. In FIG. 1, by contrast, the transport vehicle is positioned at the input side. Otherwise, however, FIGS. 2 and 3 show a cross section along line A-A in FIG. 1.

The transfer of the work object can take place by means of the work-object lifting panel 105 being completely retracted in a first position (lower position or transfer position), and therefore, when the transport vehicle 107 with the work object attached thereto is placed under the work-object lifting panel 105, there is still a spacing between the work object and the top of the work-object lifting panel 105. The work-object lifting panel 105 is then raised from this first position and can thus lift the work object from the transport vehicle 107. The work-object lifting panel 105 can then change its height position, and the worker, who is standing on the worker lifting panel 106 for example, can carry out the corresponding assembly or machining activities. After this has been done, the work-object lifting panel 105 is lowered again, for example, and the work object is again attached to or placed on the mounting means 8 of the transport vehicle 7. This can take place automatically, since in the present case these mounting means are, for example, pins that are held in a corresponding bearing that is mounted on the workpiece.

After the workpiece (not shown in the figure) has then been placed back on the transport vehicle 107, the transport vehicle 107 can continue along the guide path 114 to the exit 113 and out of the workstation enclosure 100.

In the present case, recesses are provided on the fence 115 at the input side 103 and at the output side 104, so that the workpiece can move in or out of the workstation enclosure 100 at this location.

Although in the present case the workstation enclosure 100 has the worker lifting panel 106 and the work-object lifting panel 105, it is also possible for only one of the two elements to be provided.

In the present case, the work-object lifting panel 105 also has a further slot 111, which is provided in alignment with the slot 109, so that the mounting means 108, as shown in FIG. 2, can also easily pass through in the region of the work-object lifting panel 105.

Although this cannot be clearly seen in FIGS. 1 to 3, the entrance and the exit are here provided as a kind of entrance funnel and exit funnel, respectively, with a width of 3 m and a depth of 1 m. The width is wider than the width of the guide path. This is the case because the transport vehicle can then better makes its way in, and dangerous situations, for example with people walking around in the region of the entrance and exit, can be prevented.

In particular, it is advantageous that the entrance and/or the exit in the workstation enclosure 100 is wider in the cross-sectional direction compared to a transverse direction of the guide path; in particular, the entrance and/or the exit is 30% or more wider in its cross section than the guide path. Other advantageous ranges are 40% or more wider, 50% or more wider, 100% or more wider, 200% or more wider, 1000% or more wider. The aforementioned values can be not only the lower limit, but also the upper limit of the width of the entrance or exit in relation to the guide path.

A kind of entry or exit funnel can thus be provided. With the usual dimensions of such transport vehicles, this entry funnel or exit funnel can have a width of 3 m and a depth of 1 m. Other preferred widths are 4 m, 5 m, 6 m. Other preferred depths are 2 m, 3 m, 4 m, 5 m, 6 m, 7 m. The aforementioned width and depth values can also be upper and lower limits of preferred widths and depth ranges, respectively.

The entrance or exit is provided to be wider since, in the first place, this is a safety feature and prevents people (workers) in the vicinity of the transport vehicle from being forced into the exit or entrance. In addition, this size is also advantageous insofar as the transport vehicle collects the information using its surroundings scanner and moves independently It can thus more easily make its way into the workstation enclosure 100 or out of the workstation enclosure 100.

In the present case, the transport vehicle 107 has surroundings scanners 118 at its four corners. Two of them are provided in FIG. 1; the other two are covered by the platform 101 and are not visible. The environment can be scanned via these surroundings scanners 118 and the transport vehicle 107 can enter the workstation enclosure 100 automatically. Communication between the workstation enclosure 100 and the transport vehicle 107 can be provided via a communications interface, which is not shown here. Communication can thus take place between the transport vehicle 107 and the workstation enclosure 100. For example, information can be exchanged concerning the workpiece or also the distance that the transport vehicle has to travel.

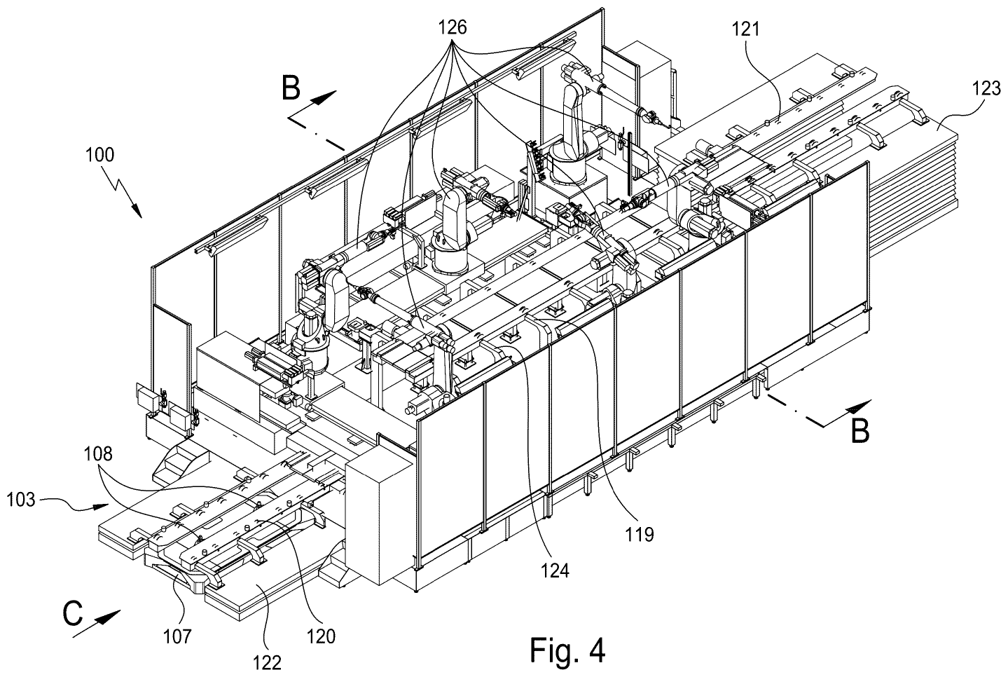

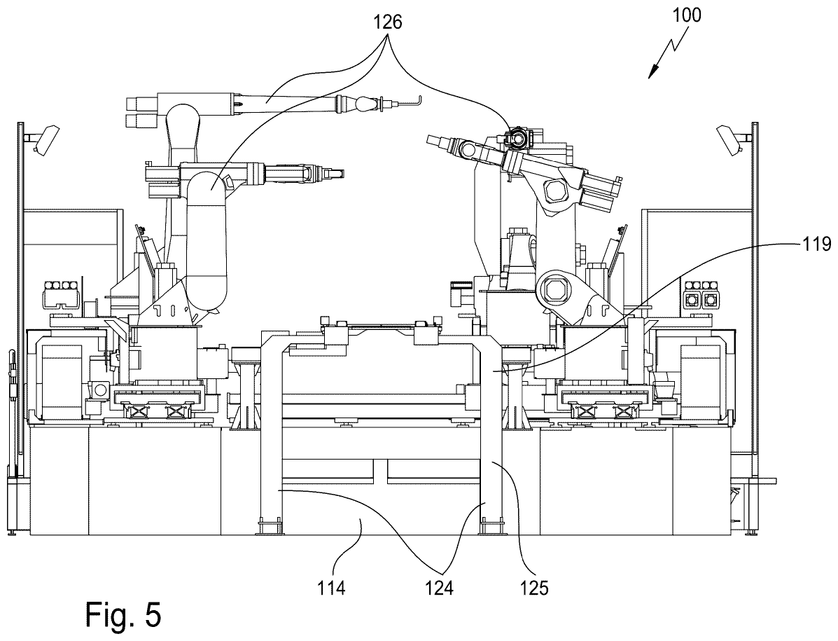

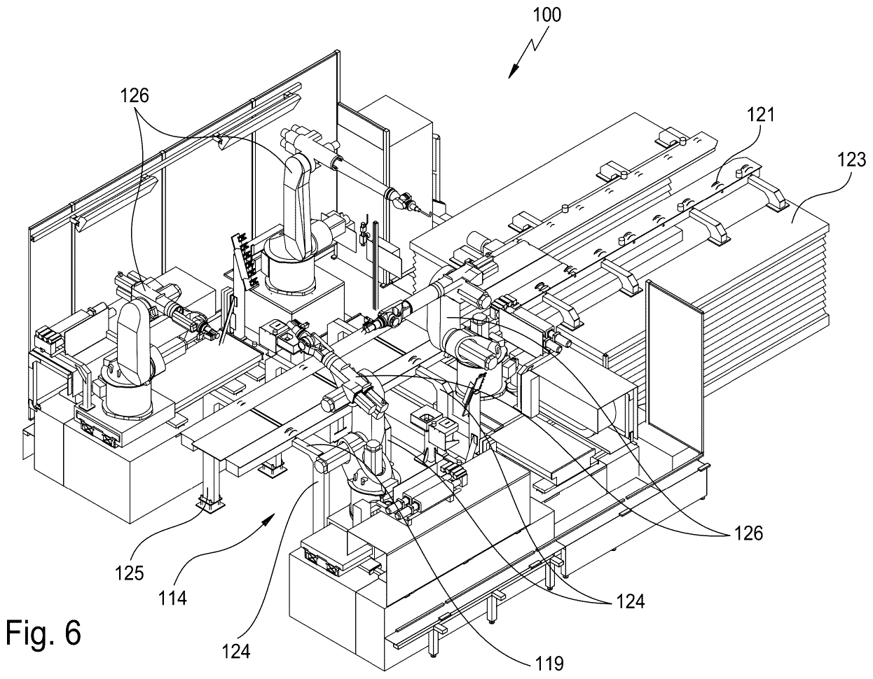

FIGS. 4 to 7 show a second exemplary embodiment, in which the workstation enclosure 100 is designed as what is called an automatic enclosure. FIG. 4 shows a perspective view of the workstation enclosure 100. FIG. 5 shows a cross-sectional view along the line B-B in FIG. 4. Another perspective cross-sectional view along the line B-B in FIG. 4 is also shown in FIG. 6.

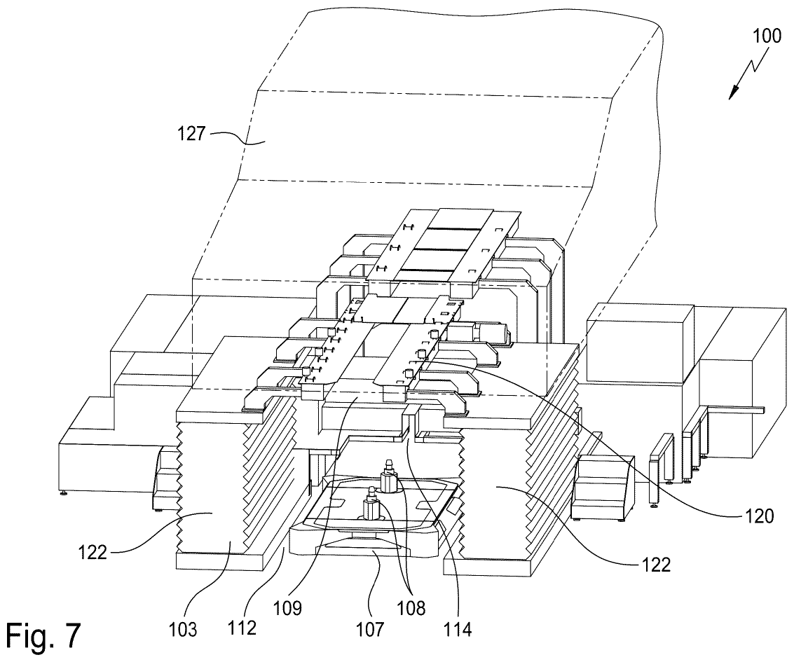

FIG. 7 shows a schematic view from the direction of the arrow C in FIG. 4. The work object is shown schematically there and labeled with reference sign 127. The work piece in this case is a vehicle body.

In the second exemplary embodiment, an input lifting panel 122 is provided at the input side 103. This input lifting panel 122 is provided in FIG. 4 in its low position, which corresponds to a transfer position for transfer between the transport vehicle 107 and an input conveyor track element 120. The input conveyor track element 120 is mounted on the input lifting panel 122.

In the present case, the conveyor track elements shown are roller conveyors. However, any other conveyor technology can be provided, and examples disclosed herein are not limited to such roller conveyors.

After the work object 127 (not shown) has been transferred from the transport vehicle 107, in the present case in the entrance 112, onto the input conveyor track element 120 mounted on the input lifting panel 122, the height of the input lifting panel 122 is adjusted and thus moved to a higher position; this position corresponds to a transfer position for transferring the workpiece 127 from the input conveyor track element 120 to the assembly and/or machining conveyor track element 119 which is provided subsequently in the line and which is provided within the workstation.

This assembly and/or machining conveyor track element 119 stands on what are called bridge elements 124, which have relatively long feet 125 mounted on the floor of the production hall. The corresponding guide path 114 from the entrance 112 to the exit 113 is formed between the feet 125 and through the bridges 124.

The work object can be moved on the assembly and/or machining conveyor track element 119 and machined there at the individual robots shown with reference sign 126, which robots are provided on the left and right sides of the assembly and/or machining conveyor track element 119.

After this step, the work object is then conveyed out onto the output conveyor track element 121. For this purpose, the output lifting panel 123 is moved to a higher position so that the output conveyor track element 121 is aligned with the assembly and/or machining conveyor track element 119. The workpiece is then transferred onto it, and then the output lifting panel 123 is lowered and the workpiece, in the lowered position, is then transferred back to the transport vehicle 107 and, for example, is attached to mounting means 108 provided there and is extended out of the workstation enclosure 100 via the exit 113.

Unlike in the first exemplary embodiment, the transfer of the work object here takes place in the entrance 112 and correspondingly in the exit 113. In the first exemplary embodiment, the transfer of the work object from the transport vehicle 107 to the workstation enclosure 100 and from the workstation enclosure 100 to the transport vehicle 107 takes place at the same position, namely at the central position.

The corresponding assembly and machining conveyor track element 119 is fixed in the present case and is not adjustable in its height direction with respect to the workstation enclosure 100.

FIG. 7 shows a further schematic view of the input side 104. It can be seen there that the transport vehicle 107 has entered the entrance 112, and the two mounting means 108 designed as pins are provided between the left and right parts of the input lifting panel 105. These can then extend in a corresponding slot 109, which is provided between the individual elements of the input conveyor track element 120, and they enable the work object to be transferred from the transport vehicle 107 to the input conveyor track element 120.

In the present example, the element with reference sign 227 is the work object, which can be a vehicle body, for example.

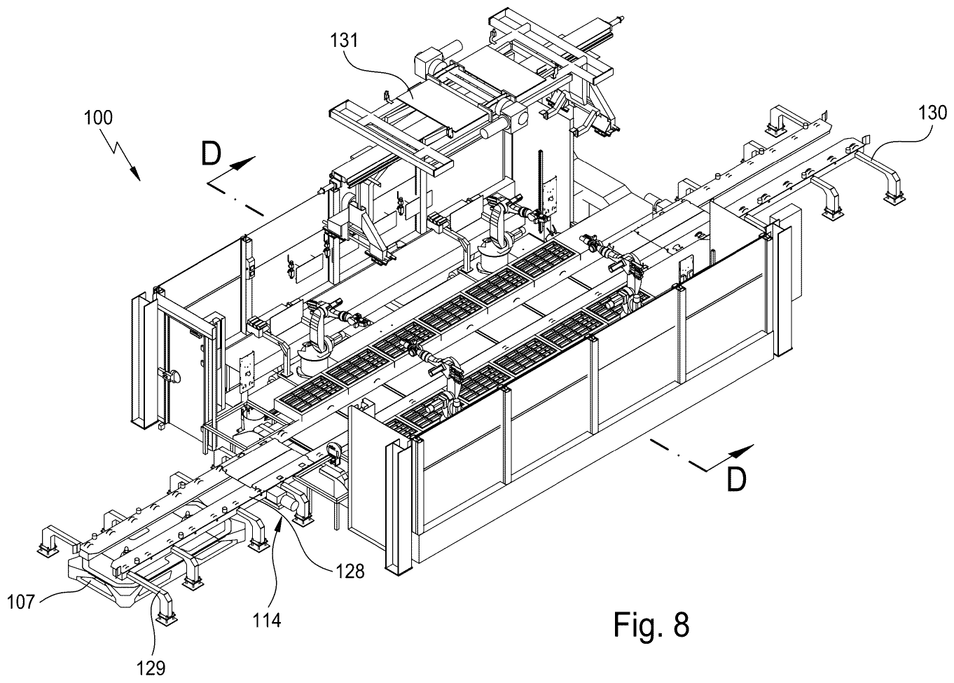

The workstation enclosure 100 in the third exemplary embodiment in FIGS. 8 to 10 is what is called a UBS enclosure.

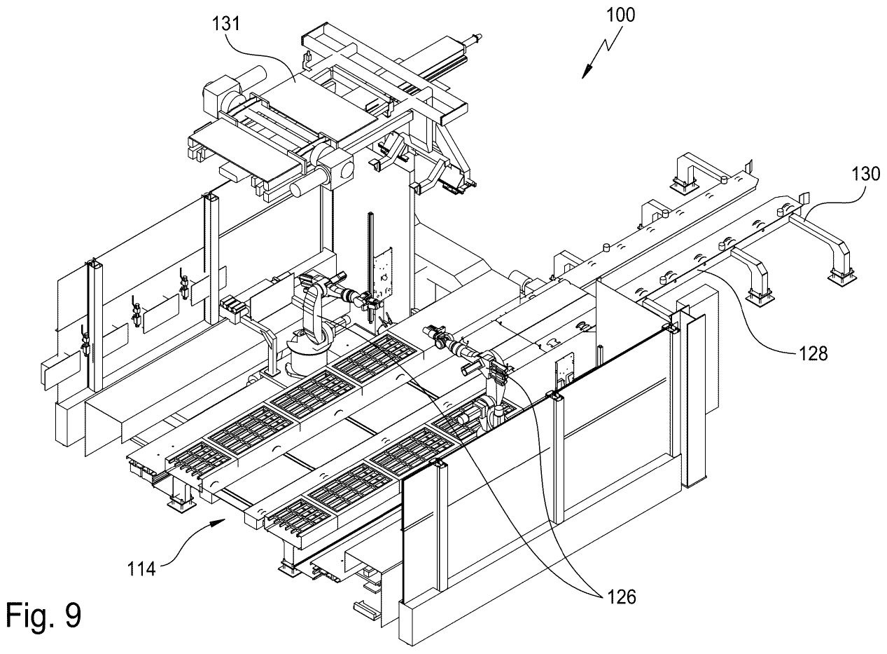

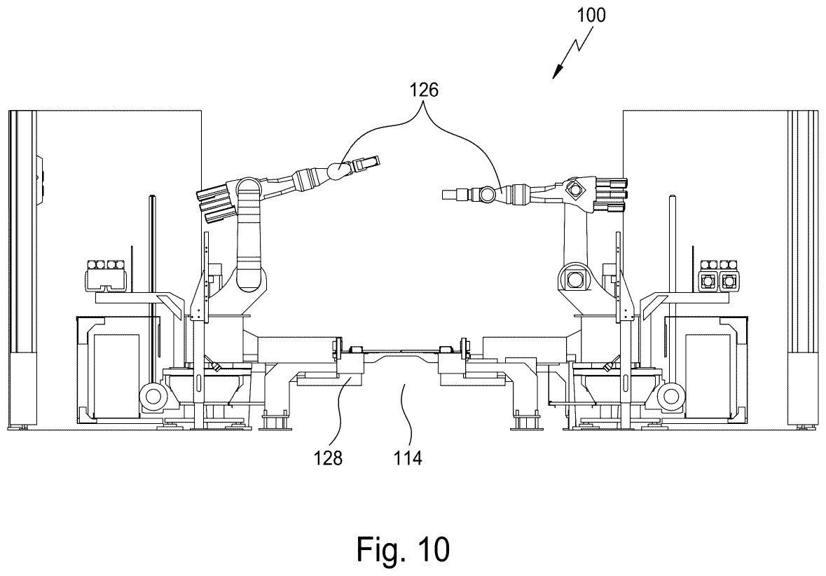

FIG. 8 shows a perspective view of the workstation enclosure 100. FIG. 9 shows a cross-sectional view along the line D-D in FIG. 8. Another perspective cross-sectional view along the line D-D in FIG. 8 is also shown in FIG. 10.

There, in contrast to the second exemplary embodiment, no separate conveyor track elements are provided, but rather a continuous conveyor track element 128 of fixed height is provided, which has an input conveyor track section 129 and an output conveyor track section 130, which are likewise part of the conveyor track element.

The transport vehicle 107 transfers the work object on the input conveyor track section 129 to the continuous conveyor track element 128 and picks it up again at the output conveyor track section 130. However, the transfer can also take place at any other location on the continuous conveyor track element 128.

This continuous conveyor track element 128 can move the work object (not shown in the figures) along the longitudinal direction within the workstation enclosure 100, and the work object can be machined there by means of the corresponding robots 126. In the present case, a further transfer of the work object takes place from the continuous conveyor track element 128 to a hanger 131, which is provided above the continuous conveyor track element 1 and is provided relatively centrally in the workstation enclosure 100.

For example, the work object can be brought into any position by the hanger 131 and then machined or assembly steps carried out on it. The work object is then transferred again from the hanger 131 to the continuous conveyor track 128 and later back to the transport vehicle 107.

In the third embodiment too, corresponding wall sections 15 are provided which delimit the workstation enclosure 100.

In the present exemplary embodiment, parts of the conveyor track element 128 or even the entire conveyor track element 128 can be folded up in its longitudinal direction. This makes it possible to access the guide path 114, for example to carry out repair work.

Even though different separate exemplary embodiments have been discussed previously, the individual elements can also be combined with one another. For example, the hanger can also be provided in the exemplary embodiment of FIG. 1. A lifting panel, for example, can also be provided in addition to one or more of the conveyor track elements in the workstation enclosure 100. Several guide paths can also be provided in parallel in a workstation, and different machining or assembly steps can then be assigned to these guide paths.

In the present case, examples disclosed herein have been described generally in relation to a workpiece. The workpiece can be, for example, a vehicle body.

### LIST OF REFERENCE SIGNS

100 workstation enclosure
101 platform
102 floor
103 input side
104 output side
105 work-object lifting panel
106 worker lifting panel
107 transport vehicle
108 mounting means
109 slot
110 seal
111 further slot (work-object lifting panel)
112 entrance
113 exit
114 guide path
115 fence/wall
116 access element
117 stairs
118 surroundings scanner
119 assembly and/or machining conveyor track element
120 input conveyor track element
121 output conveyor track element
122 input lifting panel
123 output lifting panel
124 bridge element
125 foot
126 robot
127 work object
128 continuous conveyor track element
129 input conveyor track section
130 output conveyor track section
131 hanger

1. An assembly system comprising:
a workstation enclosure in which assembly and/or machining activities can take place on a work object; and
a transport vehicle on which the work object can be releasably mounted, wherein the workstation enclosure is provided with an entrance and an exit, a guide path being provided between the entrance and the exit, along which guide path the transport vehicle can be guided from the entrance to the exit.

2. The assembly system as claimed in claim 1, wherein the entrance and/or the exit is dimensioned wider in its transverse direction compared to a transverse direction of the guide path, optionally more than 30% wider.

3. The assembly system as claimed in claim 1, wherein the guide path has mutually opposite longitudinal walls and/or route markings, which specify a route of the transport vehicle from the entrance to the exit.

4. The assembly system as claimed in claim 1, wherein the transport vehicle has a surroundings scanner, which scans the surroundings of the transport vehicle, and the transport vehicle adapts and/or find its route on the basis of information from the surroundings scanner.

5. The assembly system as claimed in claim 4, wherein the transport vehicle is configured in such a way that it independently enters the entrance on the basis of the information from the surroundings scanner.

6. The assembly system as claimed in claim 4, wherein the transport vehicle is configured in such a way that it determines its route from the entrance to the exit on the basis of the information from the surroundings scanner, or in that the route from the entrance to the exit is fixed and is determined from the position of the transport vehicle in relation to the course of the guide path.

7. The assembly system as claimed in claim 1, wherein the assembly system is configured in such a way that the workstation enclosure communicates with the transport vehicle via a communications interface.

8. The assembly system as claimed in claim 1, wherein the workstation enclosure has a work-object lifting panel to which the work object can be transferred from the transport vehicle.

9. The assembly system as claimed in claim 8, wherein the workstation enclosure has a floor in which a slot is provided between the entrance and the exit, into which slot a mounting, which is provided on the transport vehicle and by which the work object is releasably attached to the transport vehicle, can extend from an underside, and/or the assembly system is configured in such a way that, during the passage of the transport vehicle from the entrance to the exit under the workstation enclosure, the work object is transferred to the work-object lifting panel, while the transport vehicle is placed under the work-object lifting panel, that assembly and/or machining activities are carried out on the work object during the placement of the work object on the work-object lifting panel, and that the work object is then transferred from the work-object lifting panel back to the transport vehicle, and the transport vehicle leaves the workstation enclosure through the exit.

10. The assembly system as claimed in claim 9, wherein the slot is provided with a seal which closes the slot when no section of the mounting or of the work object attached to the mounting protrudes through the slot into the workstation enclosure.

11. The assembly system as claimed in claim 7, wherein the work-object lifting panel has a further slot, which is aligned with the slot in the floor of the workstation enclosure.

12. The assembly system as claimed in claim 1, wherein the workstation enclosure has a worker lifting panel on which a worker can stand when carrying out assembly and/or machining activities on the work object.

13. The assembly system as claimed in claim 1, wherein the workstation enclosure is formed by a planar platform, which is delimited optionally by a fence or wall element.

14. The assembly system as claimed in claim 1, wherein the workstation enclosure has, at the entrance, an input conveyor track element provided on an input lifting panel, and/or has, at the exit, an output conveyor track element provided on an output lifting panel, and the assembly system is configured such that the work object is transferred from the transport vehicle to the input conveyor track element in the entrance, and/or such that the work object is transferred from the output conveyor track element to the transport vehicle in the exit.

15. The assembly system as claimed in claim 14, wherein the respective conveyor track element has a slot into which there can extend, from an underside, a mounting which is provided on the transport vehicle and by which the work object is releasably attached to the transport vehicle.

16. The assembly system as claimed in claim 1, wherein the workstation enclosure has, above the guide path, an assembly and/or machining conveyor track element, which is fixedly mounted at such a vertical height that the work object can be fed from the input conveyor track element to the assembly and/or machining conveyor track element only when the input lifting table panel has performed a predetermined stroke in the height direction, and/or wherein the work object can be fed from the assembly and/or machining conveyor track element to the output conveyor track element only when the output lifting panel has performed a predetermined stroke in the height direction.

17. The assembly system as claimed in claim 14, wherein the assembly and/or machining conveyor track element does not have a slot provided in its longitudinal direction.

18. The assembly system as claimed in claim 14, wherein the workstation enclosure has one or more robots along the assembly and/or machining conveyor track element, which robots are configured to perform a respective assembly and/or machining step on the work object.

19. The assembly system as claimed in claim 1, wherein the workstation enclosure has a continuous conveyor track element which is fixed in height and which extends from the entrance to the exit, wherein the work object is transferred, in the entrance, from the transport vehicle to an input conveyor track section of the continuous fixed-height conveyor track element and is transferred, in the exit, to the transport vehicle from an output conveyor track section of the continuous fixed-height conveyor track element.

20. The assembly system as claimed in claim 19, wherein the input conveyor track section and/or the output conveyor track section projects horizontally beyond a platform which is formed by the workstation enclosure.

21. The assembly system as claimed in claim 19, wherein the workstation enclosure has a hanger at which the work object can be picked up from the continuous fixed-height conveyor track element and can be suspended thereon.

22. The assembly system as claimed in claim 19, wherein at least a section of the fixed-height conveyor track element is pivotable along its longitudinal direction.

23. A method for transferring a work object between a transport vehicle and a workstation enclosure, the method comprising:
transferring the work object from the transport vehicle to the workstation enclosure;
moving the transport vehicle under the workstation enclosure; and
transferring the work object from the workstation enclosure to the transport vehicle.
